(19) United States
(12) Patent Application Publication
(10) Pub. No.: US 2019/0079658 A1
(43) Pub. Date: Mar. 14, 2019

(54) METHOD FOR MANIPULATING A PHOTOGRAPHIC IMAGE CAPTURED BY A CAMERA OF AN INSPECTION SYSTEM

(71) Applicant: KOENIG & BAUER AG, Würzburg (DE)

(72) Inventors: David ENGELHARDT, Bielefeld (DE); Johannes SCHWEERS, Verl (DE)

(21) Appl. No.: 16/084,682

(22) PCT Filed: Mar. 15, 2017
(86) PCT No.: PCT/EP2017/056046

§ 371 Date: Sep. 13, 2018

(30) Foreign Application Priority Data
Mar. 18, 2016 (DE) 10 2016 204 540.7

(51) Int. Cl. G06F 3/0484; G06F 3/0488

(52) U.S. Cl. CPC G06F 3/04842; G06F 3/0488; G06F 3/04845

(57) ABSTRACT

A photographic image captured by a camera of an inspection system is manipulated. The photographic image captured by the camera is optically displayed on a screen which is a controller and a touch-sensitive screen surface. The controller displays a position-variable operating element with a mounting device on the screen. An object, with an object surface area with less than one millimeter square, is selected on any position and photographic image displayed on the screen, such that the marking device of the operating element is positioned at the position of the selected image by changing the position of the operating element. The control which is triggered by the positioning process of the marking device of the operating element, activates a manipulation tool. The selected object is manipulated independently of the rest of the photographic image displayed on the screen by use of the manipulation tool.

### CROSS REFERENCE TO RELATED APPLICATIONS

This application is the U.S. National Phase, under 35 U.S.C. section 371, of PCT/EP2017/056046, filed Mar. 15, 2017; published as WO 2017/157971A1 on Sep. 21, 2017 and claiming priority to DE 10 2016 204 540.7, filed Mar. 18, 2016, the disclosures of which are expressly incorporated herein in their entireties by reference.

### FIELD OF THE INVENTION

The present invention relates to a method for manipulating a photographic image captured by a camera of an inspection system. The photographic image, which is captured by the camera, is displayed visually on a screen which has a control unit and a touch-sensitive screen surface. The control unit displays a positionally variable operating element which has a marking device on the screen. At any position in the photographic image displayed on the screen, an object, having an object surface area less than 1 mm², is selected by positioning the marking device of the operating element at the position of the selected object, by changing the position of that operating element.

### BACKGROUND OF THE INVENTION

U.S. Pat. No. 7,414,741 B2 discloses an inspection system having a screen for the visual display of a photographic image, with said screen including a control unit and a touch-sensitive screen surface.

From US 2015/212698 A1, a virtual computer mouse for interaction with an electronic device is known, in which the virtual computer mouse is displayed on a touchscreen. The virtual computer mouse has a positionally variable pointer for identifying a point displayed on the touchscreen, along with a control region associated with the pointer and having at least one switch, wherein with the at least one switch, an action can be triggered with respect to the point selected by the pointer.

From US 2011/080341 A1, a curser that can be displayed on a touchscreen is known, this curser having a plurality of segments, with each of these segments being individually controllable.

From EP 2 631 766 A2, an operating device which can be actuated on a screen by scrolling is known, this operating device being controlled in a time-dependent manner.

From DE 10 2013 019425 A1, a device for operating machines and devices of the graphic arts industry which include a display device is known, in which an operating device having a touchscreen for controlling the functions of the machine or the device in the graphic arts industry and for influencing the representation displayed on the display device is provided, and in which a communication connection exists between the operating device and the display device, wherein the same screen content is displayed on the operating device and on the display device, and wherein the touchscreen of the operating device is used to modify the screen content on the operating device and on the display device in parallel.

From DE 10 2007 015097 A1, a method for performing measurements on printing substrates using a measuring device and a computer is known, in which the position of at least one reference point on the printing substrate relative to the measuring device is known by the computer; a measuring point for measurement on the printing substrate is entered via an input device on the computer, and the computer has access to an image file corresponding to the printing substrate and determines the position of the at least one reference point in the image file; the computer then calculates the relative position of the specified measuring point to the reference point in the image file, and the computer then uses the determined relative position in the image file to calculate the relative position of the measuring point to the reference point on the printing substrate; the measuring device then moves to the corresponding measuring point and performs the measurement on the printing substrate.

From DE 103 19771 A1, a system for inspecting a printed image is known, said system being equipped with at least one evaluation unit, a display device and an image sensor; the image sensor captures an image that represents at least a portion of the printed image, with the represented printed image belonging to a sequence of printed images produced on a print carrier by a printing machine, and the evaluation unit receives data that correlate to the captured image and evaluates said data by comparing them with stored data for at least one previously captured image or one reference image; the display device is equipped with a graphics-capable display surface which has multiple areas that can be controlled in different ways by the evaluation unit, with a first area displaying either the image that has just been captured, an image that was captured previously, or a reference image, and a second area including at least one input field and/or one control field for adjusting and/or controlling the evaluation unit and/or for adjusting and/or controlling the printing machine.

From WO 2014/122280 A1, a system for printing press operation of a printing press, in particular a sheet-fed printing press, is known, comprising a printing press control console and a plurality of control-side modules of the printing press distributed within the printing press; at least one three-dimensional sensor device that responds, touch-free, to gestures is provided, which is located on the printing press control console or in the operating area of the printing press control console and which can be activated by gestures performed by persons working at the printing press, and by means of which data or control signals or information actions can be generated and transmitted by gestures performed by the person working at the printing press, via an interface connected to a large screen monitor located on the printing press control console.

### SUMMARY OF THE INVENTION

The object of the present invention is to provide a method for manipulating a photographic image captured by a camera of an inspection system.

The object is attained according to the invention by the provision of the control element, being triggered by this positioning of the marking device of the operating element activating a manipulation tool. The manipulation tool is used to manipulate the selected object independently of the remainder of the photographic image displayed on the screen.

The advantages to be achieved with the present invention consist in particular in that the operation of an inspection system which is equipped with a screen for the visual display of a photographic image, in particular captured by the inspection system, is improved. Specific individual improvements will be apparent from the following description.

### BRIEF DESCRIPTION OF THE DRAWINGS

One exemplary embodiment of the invention is illustrated in the set of drawings and will be described in greater detail below.

In the drawings:

FIG. 1 shows an inspection system with a screen for the visual display of a photographic image;

FIG. 2 shows a first detail of the screen shown in FIG. 1;

FIG. 3 shows a second detail of the screen shown in FIG. 1.

### DESCRIPTION OF THE PREFERRED EMBODIMENTS

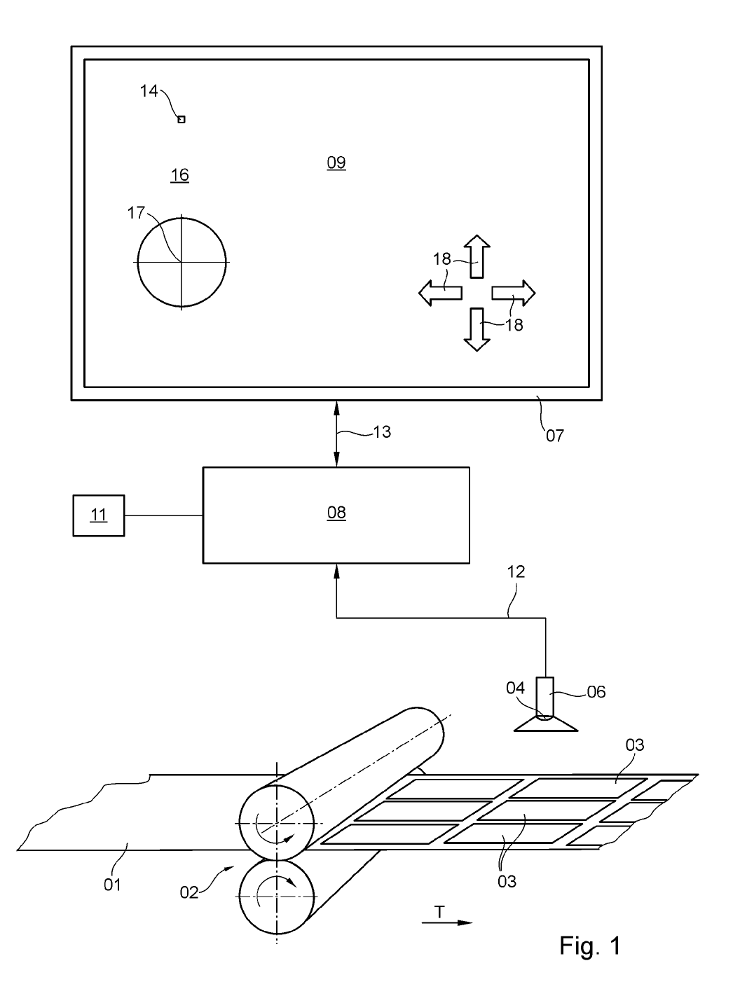

As is depicted in simple schematic form in FIG. 1, to assure the quality of printed products in a printing press 02 configured, e.g. as a rotary printing press, printed images 03 that are printed onto a printing substrate 01 in the form, e.g. of a sheet or web and that consist, due to the printing process used, e.g. of a multiplicity of printed pixels applied to the substrate 01, are captured photographically by means of a camera 06 of an inspection system, which camera includes at least one optoelectronic image sensor 04; said image sensor 04 includes, e.g. a matrix of light-sensitive photodiodes, and the respective photographic imaging of the printed print image 03 in question, carried out by the image sensor 04, is converted into computer-readable, preferably digital image data, and these image data are supplied by the camera 06 via a data line 12, e.g. to a digital control unit 08, e.g. for further processing and, where appropriate, evaluation. Camera 06 is located, e.g. in the printing press 02, in particular fixedly therein, whereas the printing substrate 01 is moved in a certain transport direction T through the printing press 02. Image sensor 04 is embodied, e.g. as a CCD sensor or as a CMOS sensor. Image sensor 04 is embodied, e.g. as a line sensor or as an area sensor. Image sensor 04 is embodied, e.g. as a monochromatic sensor or as a color sensor.

Some printed images 03 have a surface area of more than 1 square meter on the printing substrate 01, while other printed images 03 are much smaller. The photographic image of the printed image 03 in question or of at least one section of the printed image 03 in question is visualized, controlled by the control device 08, on a screen 07 for the visual display of the photographic image captured by the camera 06 of the inspection system, with said screen 07 advantageously having a touch-sensitive screen surface 09 on the viewer side. Screen 07 preferably has a plurality of pixels arranged in a grid, with the pixels each being individually controlled or at least individually controllable by the control unit 08. The grid consists, e.g. of a matrix with horizontal rows and vertical columns, in which each of the individual pixels is arranged. As a rule, the number of light-sensitive points on the image sensor 04 is different from the number of pixels on the screen 07. Screen 07 is embodied, e.g. as a liquid crystal display (LCD), in which case screen 07 has, e.g. more than 1 million, and preferably more than 2 million pixels. By actuating multiple pixels, particularly in conjunction with an appropriately close arrangement of the individual pixels, any graphic pattern or character, hereinafter referred to generally as an object 14, can be created, in particular from a plurality of adjacent pixels in the grid, preferably in the form of a matrix, in a display on the screen 07, whereby, in the present case, in particular the photographic image of the printed image 03 in question or of at least one section of the printed image 03 in question, which is present, i.e. stored, e.g. as digital image data in the control unit 08, is visualized on the screen 07. Control unit 08 thereby displays at least one section of the captured photographic image on the screen 08 in the form of an object 14, with at least some of the objects 14 displayed having an object surface area of less than 1 mm². The individual pixels of the screen 07 are each actuated, in particular actively, e.g. by means of thin film transistors (TFT). Since screen 07 advantageously has a touch-sensitive screen surface 09 and is thus configured as a touchscreen, this screen 07, which is part of the inspection system or is at least connected to the inspection system via a data line 13 which transports data bidirectionally, advantageously acts as both an input device and an output device for a person operating this inspection system, i.e. as a human-machine interface. By touching the screen surface 09, data can be entered, e.g. in the form of a control command, directly into the control unit 08, whereupon this control unit 08 in turn preferably outputs data under program control onto the screen 07.

To assess and/or ensure a certain quality of printed products, which is stipulated prior to the printing process, it may be necessary to manipulate certain objects 14 displayed on the screen 07 by means of certain operations, e.g. to display said objects enlarged in relation to a surrounding area in the printed image 03 and/or to otherwise influence said objects in a certain way so as to assure quality, e.g. by entering at least one control command into control unit 08. On a touchscreen, however, which is typically operated by a human using one finger, such input is made at least more difficult or even impossible if the object 14 displayed on the screen 07, e.g. an individual displayed printed pixel or a small number of displayed printed pixels of the photographically imaged printed image 03, has an object surface area of less than 1 mm², because the finger will at least partially or even completely cover the object 14 in question, resulting in insufficient accuracy and/or selection capability with respect to the object 14 in question in relation to other objects 14 that are displayed in the area surrounding the object 14.

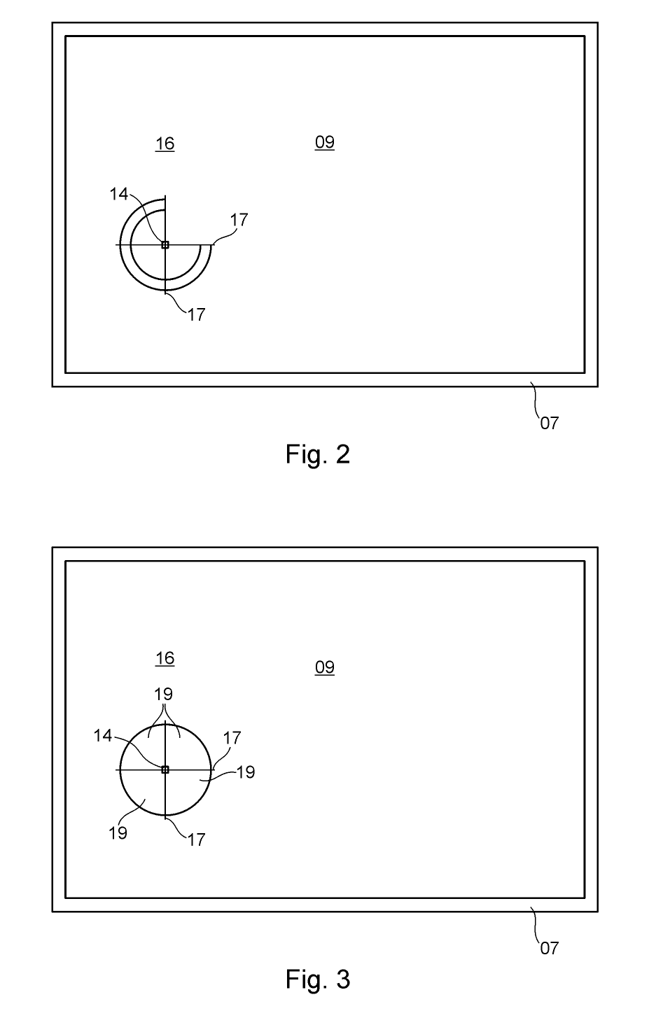

To improve the selection capability of a specific object 14 displayed on the screen 07 with respect to other objects 14 displayed in the area surrounding said object, it is proposed that the control unit 08, when triggered by touching the screen surface 09, displays on the screen 07 a two-dimensional operating element 16 having a surface area of at least 25 mm², which is large enough, in particular, to be controlled by an operator using one finger, with said operating element 16 preferably being displayed in color and being configured, e.g. as circular or as ring-shaped. Operating element 16 can also be displayed, e.g. in the form of a partial circle or an open ring (FIG. 2). The operating element 16 displayed on screen 07 is configured as positionally variable, and due to its size, it can be touched accurately in particular with one finger and then moved across the screen 07, i.e. its position can be changed, with this movement of operating element 16 being implemented, e.g. by displacing it with a finger. Operating element 16 also includes a marking device 17, e.g. in the form of crosshairs or a reticle, for example, and the marking device 17 of operating element 16 is or at least can be positioned in a position determined by the object 14 to be selected, by changing the position of said operating element 16. Thus, the marking device 17 of operating element 16 is preferably embodied as a targeting device for adjusting the position determined by the object 14 to be selected. Operating element 16 has at least one function which is activatable, in particular switched or at least switchable on and off, by control unit 08, wherein control unit 08, triggered by the successful positioning of the marking device 17 of operating element 16 at the position with respect to operating element 16 as determined by the object 14 to be selected, activates, i.e. switches on, the function of a manipulation tool, and using the operating element 16 functioning as a manipulation tool, the display of the selected object 14 on the screen 07 is or at least can be manipulated by at least one control command, entered in this manner into control unit 08, after which data which are output in response by the control unit 08 onto the screen 07 are or at least can be manipulated. As an alternative or in addition to a human using a finger to change the position of operating element 16, it can be provided for operating element 16 to be positioned using at least one control element 18 displayed by control unit 08 on screen 07, i.e. one virtual operating element, whereby a very fine, i.e. pixel-precise positioning of operating element 16 is possible. In a highly advantageous embodiment of the identified solution, the size of the surface area of operating element 16 is determined by control unit 08 based upon the size of screen surface 09. It can also be provided that the size of the surface of operating element 16 is independent of whether the object 14 displayed on screen 07 is displayed in its original size or is enlarged or reduced.

FIG. 3 shows a further detail of the screen 07 shown in FIG. 1. The operating element 16 displayed on screen 07 is preferably divided into a plurality of segments 19, and each of these segments 19 can be used for a different manipulation of the display of the selected object 14. In particular, touching a certain segment 19 of operating element 16, e.g. tapping said certain segment 19, will trigger a certain manipulation of the display of the selected object 14, e.g. a zooming in or zooming out of the selected object 14, which is different from the remaining segments 19.

A further advantageous embodiment of the identified solution provides that a time measuring device 11 is provided, which is connected to the control unit 08 and which is adjustable with respect to the period of time measurement, with the time measuring device 11 starting its time measurement as soon as the operating element 16, in particular touched by a finger, is moved to change its position. If the movement of operating element 16 ends before the period set for time measurement expires, control unit 08 will fix operating element 16 in its current position on screen 07. The time measurement period, which can be adjusted in the time measuring device 11, ranges, e.g. from 50 ms to 250 ms and is preferably approximately 150 ms. Since operating element 16 is fixed in its current position on screen 07 by control unit 08 if the movement of operating element 16 ends before the period set for time measurement expires, any unintentional displacement of operating element 16 after positioning is prevented. If the movement of operating element 16 lasts longer than the period set for time measurement, the described process is repeated by the time measuring device 11 restarting the time measurement period. The current status of operating element 16, i.e. whether or not it is fixed, is indicated, e.g. by the control unit 08 displaying operating element 16, e.g. in a different color and/or with its geometry changed, based upon its status.

The result, therefore, is an inspection system, preferably arranged in a printing press, in particular in a sheet-fed printing press, and including a preferably high resolution screen 07 for the visual display of a photographic image, captured, in particular by said inspection system, wherein this screen 07 is equipped with a control unit 08 and a touch-sensitive screen surface 09, wherein the control unit 08 displays at least one section of the photographic image on screen 08 in the form of an object 14 to be selected, having an object surface area of less than 1 mm², wherein the control unit 08, triggered by touching screen surface 09, displays a two-dimensional operating element 16 having a surface area of at least 25 mm² on the screen 07, wherein the position of operating element 16 displayed on the screen 07 is variable, wherein operating element 16 has a marking device 17, wherein the marking device 17 of operating element 16 is or at least can be positioned in a position determined by the object 14 to be selected by changing the position of said operating element 16, wherein operating element 16 has at least one function that is or at least can be switched on and off by control unit 08, wherein control unit 08, triggered by the positioning of marking device 17 of operating element 16 at the position with respect to the operating element 16 defined by the object 14 to be selected, switches on the function of a manipulation tool, and wherein using the operating element 16 functioning as a manipulation tool, the display of the selected object 14 on screen 07 is or at least can be manipulated. This inspection system can be refined and/or configured according to one or more of the features described above.

Likewise resulting from the solution is a method for manipulating a photographic image captured by a camera 06 of an inspection system, in which the photographic image captured by the camera 06 is displayed visually on a screen 07 which has a control unit 08 and a touch-sensitive screen surface 09, wherein the control unit 08 displays a positionally variable operating element 16 with a marking device 17 on the screen 07, wherein at any position in the photographic image displayed on the screen 08 an object 14 having an object surface area of less than 1 mm² is selected by positioning the marking device 17 of operating element 16 at the position of the selected object 14 by changing the position of said operating element 16, wherein the control unit 08, triggered by this positioning of the marking device 17 of operating element 16, activates a manipulation tool, wherein with the manipulation tool, only the selected object 14 is manipulated, independently of the remainder of the photographic image displayed on the screen 08. An object 14 to be selected is formed, e.g. by an individual pixel on the screen 07 or by a group of pixels, in particular adjacent pixels, on the screen 07.

In the preferred embodiment, control unit 08 displays the positionally variable operating element 16 with its marking device 17 triggered by touching the screen surface 09 on the screen 07 and/or activates the manipulation tool at the position determined by the selected object 14. The manipulation tool is used to manipulate in particular the display of the selected object 14 on the screen 07, i.e. the coloring and/or the size and/or the shape and/or the position of the selected object 14, for example. The camera 06 of the inspection system is preferably arranged in a printing press 02 embodied, e.g. as a sheet-fed printing press 02, and said camera 06 is used to capture a photographic image of at least one printed image 03 on a printing substrate 01 moving in a certain transport direction T through the printing press 02. Of course, all other features mentioned with the described inspection system may also be used in a free selection to implement the aforementioned method.

While preferred embodiments of a method for manipulating a photographic image captured by a camera of an inspection system, in accordance with the present invention, have been set forth fully and completely hereinabove, it would be apparent to one of skill in the art that changes could be made thereto without departing from the true spirit and scope of the present invention, which is accordingly to be limited only by the appended claims.

1-16. (canceled)

17. A method for manipulating a photographic image captured by a camera (06) of an inspection system, in which the photographic image captured by the camera (06) is displayed visually on a screen (07) which has a control unit (08) and a touch-sensitive screen surface (09), wherein the control unit (08) displays a positionally variable operating element (16) which has a marking device (17) on the screen (07), wherein at any position in the photographic image displayed on the screen (08) an object (14) having an object surface area of less than 1 mm2 is selected by positioning the marking device (17) of the operating element (16) at the position of the selected object (14) by changing the position of said operating element (16), characterized in that the control unit (08), triggered by this positioning of the marking device (17) of the operating element (16), activates a manipulation tool, wherein the manipulation tool is used to manipulate the selected object (14), independently of the remainder of the photographic image displayed on the screen (08), wherein the operating element (16) is positioned by means of at least one control element (18) displayed on the screen (07) by the control unit (08), wherein the operating element (16) displayed on the screen (07) is divided into a plurality of segments (19), wherein touching each of these segments (19) triggers a different manipulation of the object (14).

18. The method according to claim 17, characterized in that the control unit (08) displays the positionally variable operating element (16) in the form of a circle or a ring.

19. The method according to claim 17, characterized in that the size of the surface area of the operating element (16) is determined by the control unit (08) based upon the size of the screen surface (09).

20. The method according to claim 17, characterized in that the control unit (08) displays the positionally variable operating element (16) with a surface area of at least 25 mm².

21. The method according to claim 17, characterized in that a targeting device is used as the marking device (17) of the operating element (16).

22. The method according to claim 17, characterized in that the screen (07) has multiple pixels arranged in a grid, wherein each of the pixels is actuated individually by the control unit (08).

23. The method according to claim 17, characterized in that a time measuring device (11) is provided, which is connected to the control unit (08) and which can be adjusted in terms of the period of time measurement, wherein the time measuring device (11) starts its time measurement as soon as the operating element (16) is moved to change its position.

24. The method according to claim 23, characterized in that if the movement of the operating element (16) ends before the period set for time measurement expires, the control unit (08) will fix the operating element (16) in its current position on the screen (07).

25. The method according to claim 24, characterized in that the control unit (08) displays the operating element (16) in a different color and/or with its geometry changed, based upon whether or not it is fixed.

26. The method according to claim 17, characterized in that the control unit (08) displays the positionally variable operating element (16) with its marking device (17) on the screen (07) when triggered by a touch to the screen surface (09).

27. The method according to claim 17, characterized in that the control unit (08) activates the manipulation tool at the position determined by the selected object (14).

28. The method according to claim 17, characterized in that the manipulation tool is used to manipulate the display of the selected object (14) on the screen (07).

29. The method according to claim 17, characterized in that an object to be selected (14) is formed by an individual pixel on the screen (07) or by a group of adjacent pixels on the screen (07).

30. The method according to claim 17, characterized in that the camera (06) of the inspection system is arranged in a printing press (02), wherein this camera (06) is used to capture a photographic image of at least one printed image (03) on a printing substrate (01) moving in a certain transport direction (T) through the printing press (02).
